(19) United States
(12) Patent Application Publication
(10) Pub. No.: US 2026/0311199 A1
(43) Pub. Date: Oct. 8, 2026

(54) METHOD FOR CALCULATING TOTAL POPULARITY INDEX OF ARTIST AND SERVICE SERVER PERFORMING THE SAME

(71) Applicant: LIGHTERS COMPANY CO.,LTD, Daejeon (KR)

(72) Inventors: Ha Mi KIM, Seoul (KR); Jin Seok LEE, Seoul (KR)

(21) Appl. No.: 19/641,384

(22) Filed: Apr. 7, 2026

(30) Foreign Application Priority Data
Apr. 7, 2025 (KR) 10-2025-0044711
Apr. 7, 2025 (KR) 10-2025-0044712
Apr. 7, 2025 (KR) 10-2025-0044713
Apr. 7, 2025 (KR) 10-2025-0044714
Apr. 7, 2025 (KR) 10-2025-0044715

(51) Int. Cl. G06Q 30/0201

(52) U.S. Cl. CPC G06Q 30/02013

(57) ABSTRACT

A method for calculating a total popularity index of an artist and a service server performing the same are disclosed. The disclosed method is performed in a service server and comprises: calculating a total group streaming index of a first group artist for a specific date and a first city based on streaming data from a plurality of streaming servers; calculating a fandom index of a first member artist for the specific date and the first city based on log data of the service server corresponding to online fandom activities; and calculating a total popularity index of the first member artist for the specific date and the first city based on the total group streaming index and the fandom index. Here, the first group artist includes a first member artist.

### CROSS-REFERENCE TO RELATED APPLICATION

This application claims priority to and the benefit of (1) Korean Patent Application No. 2025-0044711, filed on Apr. 7, 2025, (2) Korean Patent Application No. 2025-0044712, filed on Apr. 7, 2025, (3) Korean Patent Application No. 2025-0044713, filed on Apr. 7, 2025, (4) Korean Patent Application No. 2025-0044714, filed on Apr. 7, 2025, and (5) Korean Patent Application No. 2025-0044715, filed on Apr. 7, 2025, the disclosure of which is incorporated herein by reference in its entirety.

### BACKGROUND

### 1. Field of the Invention

Embodiments of the present invention relate to a method for calculating a total popularity index of an artist and a service server performing the same.

Embodiments of the present invention relate to a method for calculating a current popularity index of member artists constituting a group artist and a service server performing the same.

Embodiments of the present invention relate to a method for calculating a current popularity index of an artist and a service server performing the same.

### 2. Discussion of Related Art

An artist is defined as an individual or member within a group active in the music industry, and includes performers such as singers and rappers, as well as composers, producers, and the like. Artists exert powerful influence not only by creating and performing music, but also in cultural, social, and economic aspects.

An artist's music and message influences the emotions and mindset of the public, shaping global trends or inducing social change. In order to effectively analyze such influence, technology capable of objectively and quantitatively evaluating an artist's popularity index is required.

However, in the prior art, the popularity index of an artist has often been judged based on the evaluator's intuition or subjective criteria, which has limitations in terms of reliability and consistency. In particular, when an artist is a group artist composed of two or more member artists, no technology has yet been proposed that can individually evaluate the popularity index of each member artist included in the group.

### SUMMARY OF THE INVENTION

An object of the present invention is to provide a method for effectively calculating a popularity index of an artist and a service server performing the same.

Another object of the present invention is to provide a method for individually calculating a popularity index for each member artist by taking into account the contribution of each member artist to the group artist, and a service server performing the same.

Another object of the present invention is to provide a method capable of providing an intra-city popularity index in which popularity indices of a plurality of member artists in a specific city are ranked, and an inter-city popularity index in which popularity indices of a specific member artist across a plurality of cities are ranked, and a service server performing the same.

The objects of the present invention are not limited to the objects mentioned above, and other objects and advantages of the present invention not mentioned herein may be understood from the following description and will be more clearly understood by the embodiments of the present invention. In addition, it will be readily understood that the objects and advantages of the present invention may be realized by the means and combinations thereof set forth in the claims.

A method for calculating a popularity index according to an embodiment of the present invention is performed in a service server and comprises: calculating a total group streaming index of a first group artist for a specific date and a first city based on streaming data from a plurality of streaming servers; calculating a fandom index of a first member artist for the specific date and the first city based on log data of the service server corresponding to online fandom activities; and calculating a total popularity index of the first member artist for the specific date and the first city based on the total group streaming index and the fandom index. Here, the first group artist is composed of one or more member artists including the first member artist.

A service server according to an embodiment of the present invention comprises a memory storing computer-readable instructions and a processor implemented to execute the instructions. Here, the processor calculates a total group streaming index of a first group artist for a specific date and a first city based on streaming data from a plurality of streaming servers; calculates a fandom index of a first member artist for the specific date and the first city based on log data of the service server corresponding to online fandom activities; and calculates a total popularity index of the first member artist for the specific date and the first city based on the total group streaming index and the fandom index. Here, the first group artist is composed of one or more member artists including the first member artist.

A method for calculating a popularity index according to an embodiment of the present invention is performed in a service server and comprises: calculating a current group streaming index of a first group artist for a specific date and a first city based on streaming data from a plurality of streaming servers (wherein the first group artist is composed of one or more member artists including a first member artist); a weight-setting step of setting a group streaming weight based on at least one of whether the first group artist has performed group activities within a preset specific period and whether the first member artist has performed solo activities; and calculating a current popularity index of the first member artist for the specific date and the first city based on the current group streaming index and the group streaming weight.

A service server according to an embodiment of the present invention comprises a memory storing computer-readable instructions and a processor implemented to execute the instructions. Here, the processor calculates a current group streaming index of a first group artist for a specific date and a first city based on streaming data from a plurality of streaming servers (wherein the first group artist is composed of one or more member artists including a first member artist); sets a group streaming weight based on at least one of whether the first group artist has performed group activities within a preset specific period and whether the first member artist has performed solo activities; and calculates a current popularity index of the first member artist for the specific date and the first city based on the current group streaming index and the group streaming weight.

A method for calculating a popularity index according to an embodiment of the present invention is performed in a service server and comprises: calculating a current group streaming index of a first group artist for a specific date and a first city based on streaming data from a plurality of streaming servers; and calculating a current popularity index of a first member artist for the specific date and the first city based on the current group streaming index and a predefined group streaming weight. Here, the first group artist is composed of one or more member artists including the first member artist.

A service server according to an embodiment of the present invention comprises a memory storing computer-readable instructions and a processor implemented to execute the instructions. Here, the processor calculates a current group streaming index of a first group artist for a specific date and a first city based on streaming data from a plurality of streaming servers; and calculates a current popularity index of a first member artist for the specific date and the first city based on the current group streaming index and a predefined group streaming weight. Here, the first group artist is composed of one or more member artists including the first member artist.

According to the present invention, a popularity index of an artist can be effectively calculated.

In addition, according to the present invention, a popularity index can be individually calculated for each member artist by taking into account the contribution of each member artist to the group artist.

In addition, according to the present invention, it is possible to provide an intra-city popularity index in which popularity indices of a plurality of member artists in a specific city are ranked, and an inter-city popularity index in which popularity indices of a specific member artist across a plurality of cities are ranked.

The effects of the present invention are not limited to those described above and should be understood to include all effects that can be inferred from the detailed description or the configuration of the invention described in the claims.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a schematic configuration of a popularity index calculation system according to an embodiment of the present invention.

FIG. 2 is a diagram illustrating a schematic configuration of a service server according to an embodiment of the present invention.

FIG. 3 is a diagram illustrating an overall flowchart of a popularity index calculation method according to an embodiment of the present invention.

FIG. 4 is a diagram illustrating a detailed flowchart of some of the steps in FIG. 3.

FIG. 5 is a diagram for explaining the concept of calculating a fandom index by a service server according to an embodiment of the present invention.

FIG. 6 is a diagram illustrating an overall flowchart of a popularity index calculation method according to another embodiment of the present invention.

FIG. 7 is a diagram illustrating a detailed flowchart of some of the steps in FIG. 6.

FIG. 8 is a diagram for explaining the concept of some steps in FIG. 7.

FIG. 9A and FIG. 9B are a diagram illustrating an example of an intra-city popularity index and an inter-city popularity index as defined in the present invention.

### DETAILED DESCRIPTION OF EXEMPLARY EMBODIMENTS

The present invention may be embodied in various modifications and may have various embodiments, and specific embodiments are illustrated in the drawings and described in detail. However, this is not intended to limit the present invention to specific embodiments, and should be understood to include all modifications, equivalents, and substitutes within the spirit and technical scope of the present invention. Similar reference numerals have been used for similar components throughout the description of each drawing.

Terms such as “first” and “second” may be used to describe various components, but such components should not be limited by these terms. These terms are used only for the purpose of distinguishing one component from another. The term “and/or” includes any combination of a plurality of related listed items or any one of a plurality of related listed items.

When a component is referred to as being “connected” or “coupled” to another component, it may be directly connected or coupled to the other component, but it should be understood that other components may exist in between. In contrast, when a component is referred to as being “directly connected” or “directly coupled” to another component, it should be understood that no other components exist in between.

The terms used herein are merely used to describe specific embodiments and are not intended to limit the present invention. Singular expressions include plural expressions unless the context clearly dictates otherwise. In this application, terms such as “comprise” or “have” are intended to designate the existence of features, numbers, steps, operations, components, parts, or combinations thereof described in the specification, and are not to be understood as precluding in advance the possibility of the existence or addition of one or more other features, numbers, steps, operations, components, parts, or combinations thereof.

Unless otherwise defined, all terms used herein, including technical and scientific terms, have the same meaning as commonly understood by a person of ordinary skill in the art to which the present invention belongs. Terms defined in commonly used dictionaries should be interpreted as having meanings consistent with the meanings they have in the context of the relevant technology, and unless explicitly defined in the present application, should not be interpreted in an ideal or excessively formal sense.

Hereinafter, embodiments according to the present invention will be described in detail with reference to the accompanying drawings.

FIG. 1 is a diagram illustrating a schematic configuration of a popularity index calculation system according to an embodiment of the present invention.

Referring to FIG. 1, a popularity index calculation system 1 (hereinafter referred to as “system”) according to an embodiment of the present invention may include a plurality of terminal devices 10, a service server 20, and a plurality of streaming servers 30.

Each of the plurality of terminal devices 10 may be a processor-based device owned by a user. Here, the user corresponds to a fan of a specific artist.

The service server 20 may be a processor-based device that is communicatively connected to each of the plurality of terminal devices 10 and provides fandom services to a plurality of users corresponding to fans.

Here, a fandom service may be defined as a platform or service that promotes fan participation and communication regarding an artist. Through fandom services, fans can strengthen their bond with an artist. For example, fandom services may include fan participation services such as fan voting for artists and posting comments in artist communities, content provision services providing various content such as music, videos, and interviews of artists, merchandise sales services selling fan goods, albums, concert tickets, and the like related to artists, and event services providing events such as fan meetings. The activities of fans using such fandom services may correspond to online fandom activities for a specific artist, and data related to fandom services may be stored as log data within the service server 20.

In addition, the service server 20 may calculate a popularity index for each artist based on the log data and streaming data obtained from the plurality of streaming servers 30. This will be described in more detail below.

Each of the plurality of streaming servers 30 may be a processor-based device that provides music streaming platform services or video streaming platform services. Each of the plurality of streaming servers 30 may transmit streaming data related to statistics of streaming records of the music streaming platform service or video streaming platform service to the service server 20.

Specifically, the plurality of streaming servers 30 may include two or more first streaming servers 30 providing music streaming platform services. Here, the first streaming server 30 may correspond to music platforms widely used in many countries. For example, the first streaming server 30 may be a streaming server corresponding to Spotify, Apple Music, Deezer, iTunes, Shazam, Amazon Music, and the like.

Meanwhile, each of the two or more first streaming servers 30 may generate and manage a music chart. Here, a music chart may include at least one of a music chart for music tracks and a music chart for music albums. Music charts may be generated by city or by country.

In addition, the plurality of streaming servers 30 may include one or more second streaming servers 30 providing video streaming platform services. Here, the second streaming server 30 may also correspond to video platforms widely used in many countries. For example, the second streaming server 30 may be a streaming server corresponding to YouTube, TikTok, and the like.

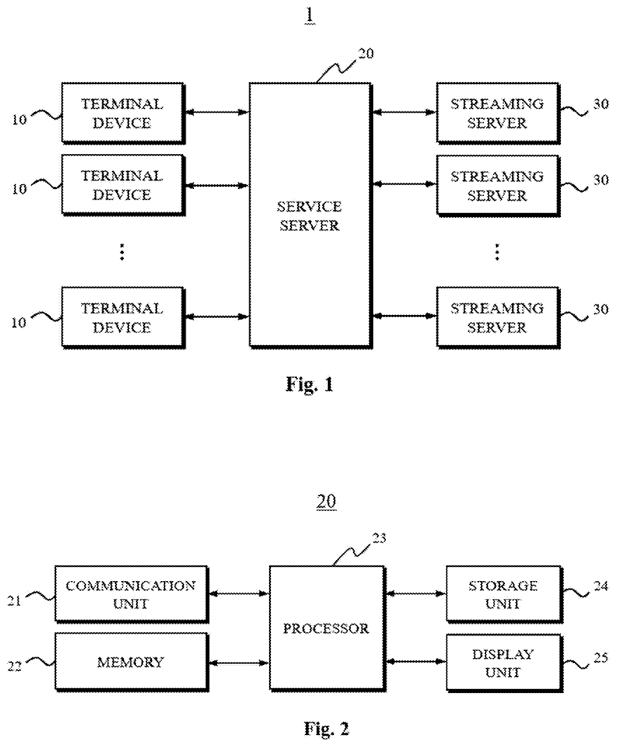

Hereinafter, the configuration of the service server 20 will be described with reference to FIG. 2.

FIG. 2 is a diagram illustrating a schematic configuration of the service server 20 according to an embodiment of the present invention.

Referring to FIG. 2, the service server 20 may include a communication unit 21, a memory 22, a processor 23, a storage unit 24, and a display unit 25.

The communication unit 21 may communicate with the plurality of terminal devices 10 and the plurality of streaming servers 30. For example, the communication unit 21 may be a short-range communication module and/or a long-range communication module. The short-range communication module may be a communication module based on Bluetooth, RFID (radio frequency identification), IrDA (infrared data association), UWB (ultra-wideband), ZigBee, or WiFi (Wireless Fidelity). The long-range communication module may be a communication module based on CDMA (code division multiple access), FDMA (frequency division multiple access), TDMA (time division multiple access), OFDMA (orthogonal frequency division multiple access), or SCFDMA (single carrier frequency division multiple access).

The memory 22 may be volatile and/or non-volatile memory and may store instructions or data related to at least one other component of the service server 20. In particular, the memory 22 may store instructions or data related to computer programs, applications, recording media, and the like executed in the service server 20.

The processor 23 may include one or more of a central processing unit, an application processor, or a communication processor. The processor 23 may execute operations or data processing related to control and/or communication of at least one other component of the service server 20. In particular, the processor 23 may execute instructions of computer programs/applications.

The storage unit 24 may store various data. In particular, the storage unit 24 may store the aforementioned log data.

The display unit 25 may be configured with a liquid crystal display (LCD), a light emitting diode display (LED), an organic light emitting diode display (OLED), or the like, and is a device capable of displaying images or image frames. In particular, the display unit 25 may output an execution screen of a computer program or application executed by the processor 23.

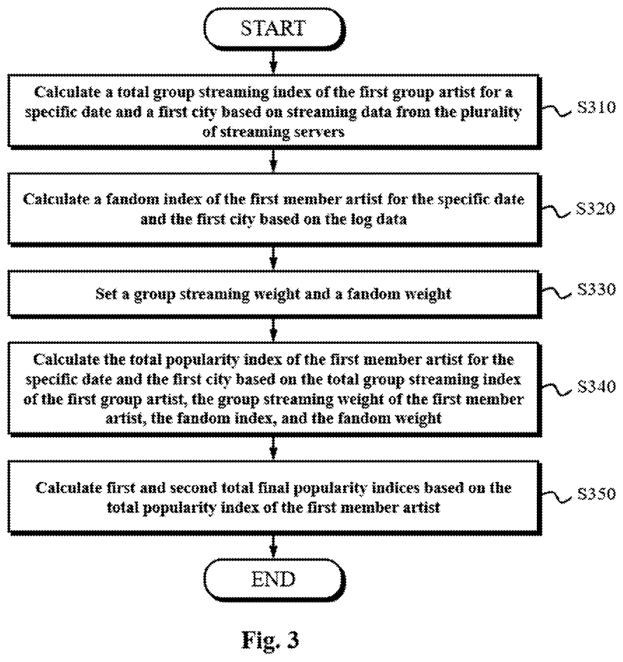

Hereinafter, the method for calculating a popularity index of an artist performed by the processor 23 of the service server 20 will be described in detail with reference to FIG. 3 and others.

FIG. 3 is a diagram illustrating an overall flowchart of a popularity index calculation method according to an embodiment of the present invention.

Here, the group artist to be described in FIG. 3 may be composed of one or more member artists. That is, a group artist may consist of only one member artist or may be composed of two or more member artists. In this case, when a group artist includes only one member artist, the group artist may be a solo artist. Hereinafter, the member artist whose popularity index is to be calculated is referred to as the first member artist, and the group artist to which the first member artist belongs is referred to as the first group artist. For example, the first group artist may be BTS, and the first member artist may be V.

In addition, the popularity index may be a total popularity index of the first member artist, which is the popularity index of the first member artist up to a specific date. Here, the total popularity index may correspond to a cumulative popularity index, a long-term popularity index, a career popularity index, an overall popularity index, and the like of the first member artist.

Hereinafter, the steps of FIG. 3 will be described in detail.

Step S310: The service server 20 may calculate a total group streaming index of the first group artist for a specific date and a first city based on streaming data from the plurality of streaming servers 30.

Here, the streaming data may be data related to statistics of streaming records of the streaming server 30 for the first group artist, and the group streaming index may be a streaming index for the first group artist. Meanwhile, the specific date may be the current date, and the first city may be a specific city such as New York, Paris, Madrid, or Tokyo.

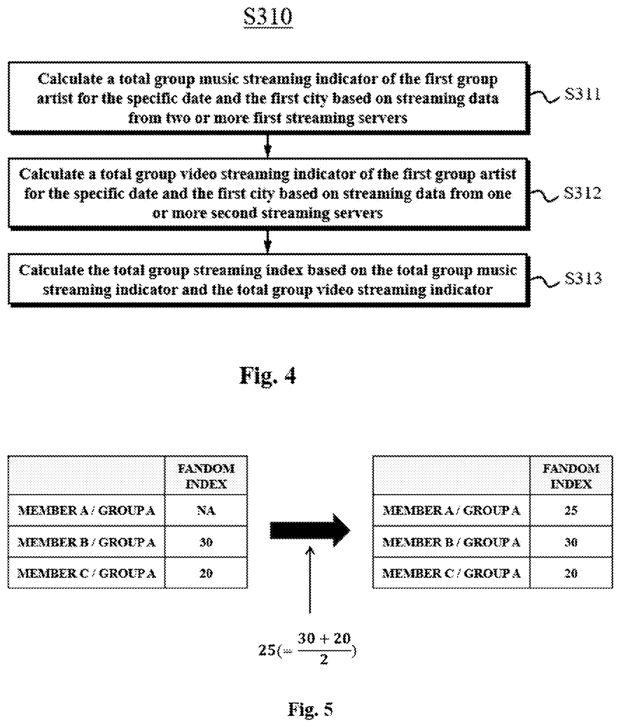

FIG. 4 is a diagram illustrating a detailed flowchart of step S310 among the steps of FIG. 3.

First, in Step S311, the service server 20 may calculate a total group music streaming indicator of the first group artist for the specific date and the first city based on streaming data from two or more first streaming servers 30.

As described above, the first streaming server 30 may be a streaming server providing music streaming platform services. In addition, the total group music streaming indicator may be related to music tracks and/or music albums of the first group artist.

Specifically, the service server 20 may calculate the total group music streaming indicator based on at least one of first, second, and third total group music streaming indicators.

According to an embodiment, the first total group music streaming indicator may be related to the number of listeners who listened to the music tracks of the first group artist in the first city up to the specific date.

As an example, the service server 20 may calculate the first total group music streaming indicator based on the sum of the number of monthly listeners in the first city up to the specific date.

Meanwhile, the first total group music streaming indicator may be calculated from the streaming data of the aforementioned Spotify. In this case, the number of listeners who listened to the music tracks of the first group artist may be calculated based on the all-time highest number of monthly listeners.

According to an embodiment, the second total group music streaming indicator may be related to the number of music tracks of the first group artist listed on the music chart of the first city up to the specific date, and the third total group music streaming indicator may be related to the number of music albums of the first group artist listed on the music chart of the first city up to the specific date.

As an example, when the number of music tracks of the first group artist listed on the music charts of each of three streaming servers 30 up to the specific date are M1, M2, and M3 respectively, the service server 20 may calculate the second total group music streaming indicator based on the average or weighted average of M1, M2, and M3. When the number of music albums of the first group artist listed on the music charts of each of three streaming servers 30 up to the specific date are N1, N2, and N3 respectively, the service server 20 may calculate the third total group music streaming indicator based on the average or weighted average of N1, N2, and N3.

Meanwhile, the second total group music streaming indicator may be calculated from streaming data for the music charts of the first city on each of the aforementioned Spotify, Apple Music, Deezer, iTunes, Shazam, and Amazon Music. In this case, for Shazam, streaming data for the music chart of the first country to which the first city belongs may additionally be used. The third total group music streaming indicator may be calculated from streaming data for the music charts of the first city on each of the aforementioned Apple Music, Deezer, iTunes, and Amazon Music.

Next, in Step S312, the service server 20 may calculate a total group video streaming indicator of the first group artist for the specific date and the first city based on streaming data from one or more second streaming servers 30.

As described above, the second streaming server 30 may be a streaming server providing video streaming platform services. In addition, the total group video streaming indicator may be related to videos of the first group artist.

Specifically, the service server 20 may calculate the total group video streaming indicator based on the view count of the first group artist's videos up to the specific date. View counts may be aggregated for viewers worldwide.

Here, the first group artist's videos may be videos produced by a video creator based in the first city, based on the music tracks of the first group artist. That is, the video creator may be a creator residing in the first city.

Meanwhile, the total group video streaming indicator may be calculated from the streaming data of the aforementioned YouTube and TikTok.

Continuing to Step S313, the service server 20 may calculate the total group streaming index based on the total group music streaming indicator and the total group video streaming indicator.

As an example, the service server 20 may calculate the total group streaming index as the total sum or weighted sum of the total group music streaming indicator and the total group video streaming indicator.

Referring again to FIG. 3, in Step S320, the service server 20 may calculate a fandom index of the first member artist for the specific date and the first city based on the log data.

As described above, log data corresponding to online fandom activities may be stored in the storage unit 24, and the service server 20 may calculate the fandom index of the first member artist for the specific date and the first city based on the log data.

According to an embodiment, the service server 20 may calculate the fandom index based on at least one of first and second fandom indicators.

The first fandom indicator may be related to a popularity vote for member artists in the first city conducted on the service server 20. Here, the popularity vote may be a free popularity vote, including a preliminary popularity vote and a main popularity vote. The value of the popularity vote may be the cumulative value of the first member artist's popularity votes up to the specific date.

In addition, the second fandom indicator may be related to payment information of fans based in the first city for goods related to the first member artist. Here, goods may include fan goods of the first member artist, concert tickets, participation in paid popularity votes, and the like.

As an example, the payment information may be information about payment for goods using digital assets sold for a fee on the service server 20. As another example, the payment information may be information about direct payment for goods using a credit card or the like through the service server 20.

Meanwhile, the fandom index may be further calculated based on various additional fandom indicators. Here, additional fandom indicators may include at least one of: the number of follows of the first member artist's community opened on the service server 20; the number of searches in the community; the number of views of the community; the number of posts written in the community; the number of times posts are saved; the number of views of posts; the number of comments on posts; the number of likes on comments; the number of views of content associated with the first member artist; the number of times content is saved; the number of likes on content; the number of comments on content; the number of likes on comments on content; and the number of participations in events associated with the first member artist.

Meanwhile, there may be cases where the log data for the first member artist is missing data. In this case, in Step S320, the service server 20 may further calculate the fandom index of other member artists of the first group artist for the specific date and the first city based on the log data, and may calculate (i.e., infer) the fandom index of the first member artist based on a statistical value of the fandom indices of the other member artists. As an example, the service server 20 may calculate the average value of the fandom indices of the other member artists as the fandom index of the first member artist.

FIG. 5 is a diagram for explaining the concept of the operation of the service server 20 for calculating the fandom index of the first member artist according to an embodiment of the present invention.

Referring to FIG. 5, the fandom indices of member artists B and C (i.e., other member artists) of group artist A have been calculated, but the fandom index of member artist A (i.e., the first member artist) of group artist A has not been calculated. In this case, the service server 20 may calculate the average value of the fandom index of member artist B (i.e., 30) and the fandom index of member artist C (i.e., 20), which is 25, as the fandom index of member artist A.

Referring again to FIG. 3, in Step S330, the service server 20 may set a group streaming weight and a fandom weight.

Here, the group streaming weight is a weight related to the total group streaming index and may have any value between 0 and 1. The group streaming weight may be set based on whether the first group artist has performed group activities within a preset specific period and the number of member artists included in the first group artist. In addition, the fandom weight is a weight related to the fandom index, may have any value between 0 and 1, and may in particular be set to a specific fixed value (for example, a third value).

According to a first embodiment, when the first group artist is composed of two or more member artists including the first member artist and the first group artist performs group activities within the specific period, the service server 20 may set the group streaming weight to have a first value corresponding to the contribution of the first member artist to the first group artist.

Specifically, in Step S320, the service server 20 may further calculate the fandom index of other member artists of the first group artist for the specific date and the first city based on the log data. The fandom index of other member artists may be calculated similarly to the fandom index of the first member artist described above. In this case, in Step S330, the service server 20 may calculate the first value based on the fandom indices of two or more member artists. According to an embodiment, the service server 20 may set the ratio of the fandom index of the first member artist to the sum or weighted sum of the fandom indices of the two or more member artists as the first value.

According to a second embodiment, when the first group artist is a solo artist including only the first member artist, the service server 20 may set the group streaming weight to have a preset second value. In this case, the second value may have a fixed value.

According to a third embodiment, when the first group artist is composed of two or more member artists including the first member artist but the first group artist does not perform group activities during the specific period, the service server 20 may set the group streaming weight to have the second value. That is, since the aforementioned first member artist is essentially a solo artist, the first member artist may be assigned the same group streaming weight as a solo artist.

In Step S340, the service server 20 may calculate the total popularity index of the first member artist for the specific date and the first city based on the total group streaming index of the first group artist, the group streaming weight of the first member artist, the fandom index, and the fandom weight.

According to an embodiment, the service server 20 may calculate the total popularity index of the first member artist based on an operation value A obtained by multiplying the group streaming weight of the first member artist and the total group streaming index of the first group artist, and an operation value B obtained by multiplying the fandom weight of the first member artist and the fandom index. This may be expressed as Equation 1 below.

Total Popularity Index=(Fandom Weight×Fandom Index)+(Group Streaming Weight×Total Group Streaming Index) [Equations 1]

Meanwhile, there may be cases where the first group artist is composed of two or more member artists including the first member artist, and within the specific period, the first group artist performs group activities while the first member artist also performs solo activities. In this case, the total streaming index related to the solo activities of the first member artist must be included in the total popularity index of the first member artist. Therefore, the service server 20 may further calculate a total member streaming index of the first member artist performing solo activities, further set a member streaming weight related to the total member streaming index, and calculate the total popularity index of the first member artist further based on the total member streaming index and the member streaming weight.

Specifically, in Step S310, the service server 20 may further calculate a total member streaming index of the first member artist for the specific date and the first city based on streaming data from the plurality of streaming servers 30. Here, the total member streaming index may be calculated similarly to the total group streaming index described above.

More specifically, the total member streaming index may be calculated based on a total member music streaming indicator and a total member video streaming indicator. In this case, the total member music streaming indicator may be calculated based on at least one of: a first total member music streaming indicator related to the number of listeners who listened to the music tracks of the first member artist in the first city up to the specific date; a second total member music streaming indicator related to the number of music tracks of the first member artist listed on the music chart of the first city up to the specific date; and a third total member music streaming indicator related to the number of music albums of the first member artist listed on the music chart of the first city up to the specific date. In addition, the total member video streaming indicator may be calculated based on the view count of videos of the first member artist up to the specific date, and the videos of the first member artist may be videos related to the music tracks of the first member artist.

Thereafter, in Step S330, the service server 20 may further set a member streaming weight. In this case, the member streaming weight may have any value between 0 and 1, and in particular may be set to the second value. Meanwhile, the group streaming weight may be set to the first value corresponding to the aforementioned contribution.

Next, in Step S340, the service server 20 may calculate the total popularity index of the first member artist further based on the total member streaming index and the member streaming weight.

According to an embodiment, the service server 20 may calculate a first operation value based on a first average value of the group streaming weight and the member streaming weight and a second average value of the total group streaming index and the total member streaming index; calculate a third operation value based on the fandom weight and the fandom index; and calculate the total popularity index based on the first and third operation values. This may be expressed as Equation 2 below.

Total Popularity Index=First Operation Value+Third Operation Value=(First Average Value×Second Average Value)+Third Operation Value [Equation 2]

Where: First Average Value=(Group Streaming Weight+Member Streaming Weight)/2 Second Average Value=(Total Group Streaming Index+Total Member Streaming Index)/ 2

According to another embodiment, the service server 20 may calculate a second operation value based on a first multiplication value of the group streaming weight and the total group streaming index and a second multiplication value of the member streaming weight and the total member streaming index; calculate a third operation value based on the fandom weight and the fandom index; and calculate the total popularity index based on the second and third operation values. This may be expressed as Equation 3 below.

Total Popularity Index=Second Operation Value+Third Operation Value=(First Multiplication Value+Second Multiplication Value)+Third Operation Value [Equation 3]

Where: First Multiplication Value=Group Streaming Weight×Total Group Streaming Index Second Multiplication Value=Member Streaming Weight×Total Member Streaming Index

Referring again to FIG. 3, in Step S350, the service server 20 may calculate first and second total final popularity indices based on the total popularity index of the first member artist.

According to an embodiment, the first total final popularity index may be defined as an intra-city popularity index in which popularity indices of a plurality of member artists in a specific city are ranked.

To this end, the service server 20 may further calculate a total group streaming index for each of one or more second group artists for the specific date and the first city in Step S310, and may further calculate a fandom index for each of a plurality of second member artists for the specific date and the first city based on log data in Step S320. In this case, each of the plurality of second member artists may be included in any one of a plurality of group artists including the first group artist and one or more second group artists. In addition, the service server 20 may further calculate a group streaming weight for each of one or more second group artists and a fandom weight for each of a plurality of second member artists in Step S330, and may further calculate a total popularity index for each of the plurality of second member artists for the specific date and the first city based on the total group streaming index and group streaming weight for each of one or more second group artists and the fandom index and fandom weight for each of the plurality of second member artists in Step S340.

When the aforementioned Steps S310, S320, S330, and S340 are performed, in Step S350, the service server 20 may calculate the intra-city popularity index by normalizing or standardizing and then ranking the total popularity index of the first member artist and the total popularity indices of each of the plurality of second member artists.

According to an embodiment, the second total final popularity index may be defined as an inter-city popularity index in which popularity indices of a specific member artist across a plurality of cities are ranked.

To this end, in Step S310, the service server 20 may further calculate a total group streaming index for each of one or more second cities for the specific date and the first group artist, and in Step S320, may further calculate a fandom index for each of one or more second cities for the specific date and the first member artist based on log data. In addition, in Step S330, the service server 20 may further set a group streaming weight and fandom weight for each of one or more second cities for the first group artist, and in Step S340, may further calculate the total popularity index of the first member artist for the specific date and each of the one or more second cities based on the total group streaming index and group streaming weight for each of the one or more second cities and the fandom index and fandom weight for each of the one or more second cities.

When the aforementioned Steps S310, S320, S330, and S340 are performed, in Step S350, the service server 40 may calculate the inter-city popularity index by normalizing or standardizing and then ranking the total popularity index of the first member artist for the first city and the total popularity index of the first member artist for each of the one or more second cities.

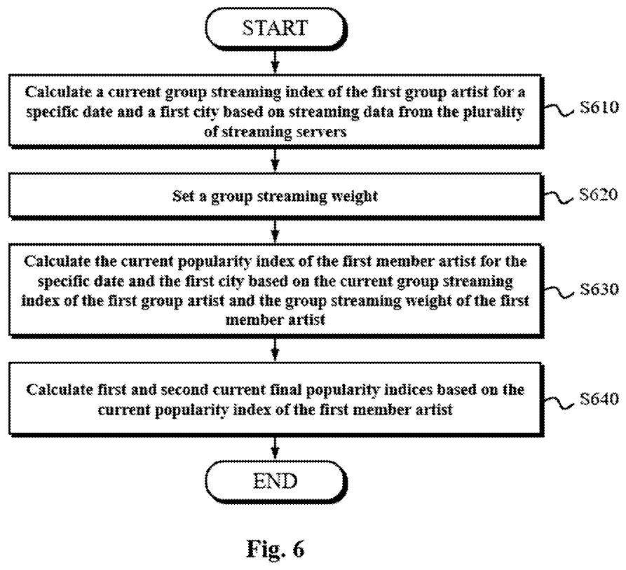

Hereinafter, the method for calculating a popularity index of an artist performed by the processor 23 of the service server 20 will be described in detail with reference to FIG. 6 and others.

FIG. 6 is a diagram illustrating an overall flowchart of a popularity index calculation method according to another embodiment of the present invention.

Here, the group artist to be described in FIG. 6 may be composed of one or more member artists. That is, a group artist may consist of only one member artist or may be composed of two or more member artists. In this case, when a group artist includes only one member artist, the group artist may be a solo artist. Hereinafter, the member artist whose popularity index is to be calculated is referred to as the first member artist, and the group artist to which the first member artist belongs is referred to as the first group artist. For example, the first group artist may be BTS, and the first member artist may be V.

In addition, the popularity index may be a current popularity index of the first member artist, which is the popularity index of the first member artist on the specific date itself. Here, the current popularity index may correspond to a short-term popularity index, a recent popularity index, and the like of the first member artist.

Hereinafter, the steps of FIG. 6 will be described in detail.

Step S610: The service server 20 may calculate a current group streaming index of the first group artist for a specific date and a first city based on streaming data from the plurality of streaming servers 30.

Here, the streaming data may be data related to statistics of streaming records of the streaming server 30 for the first group artist, and the group streaming index may be a streaming index for the first group artist. Meanwhile, the specific date may be the current date, and the first city may be a specific city such as New York, Paris, Madrid, or Tokyo.

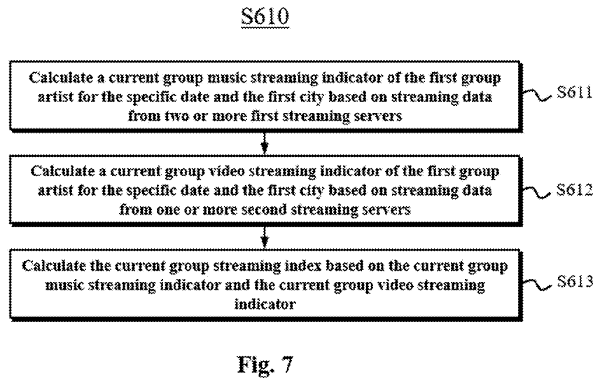

FIG. 7 is a diagram illustrating a detailed flowchart of step S610 among the steps of FIG. 6.

First, in Step S611, the service server 20 may calculate a current group music streaming indicator of the first group artist for the specific date and the first city based on streaming data from two or more first streaming servers 30.

As described above, the first streaming server 30 may be a streaming server providing music streaming platform services. In addition, the current group music streaming indicator may be related to music tracks and/or music albums of the first group artist.

Specifically, the service server 20 may calculate the current group music streaming indicator based on at least one of first, second, and third current group music streaming indicators.

According to an embodiment, the first current group music streaming indicator may be related to the number of listeners who listened to the music tracks of the first group artist in the first city during a preset first period ending on the specific date.

As an example, when the specific date is February 12, the first period may be from January 15 to February 12 (a period of 28 days, corresponding to a month), and the service server 20 may calculate the first current group music streaming indicator based on the number of listeners who listened to the music tracks of the first group artist from January 15 to February 12.

More specifically, the service server 20 may calculate the first current group music streaming indicator based on the number of listeners in the first city for each of two or more dates included in the first period. For example, the service server 20 may calculate the total sum of the number of listeners in the first city for each of two or more dates as the first current group music streaming indicator.

In this case, there may be cases where the number of listeners in the first city for a first date among the two or more dates is a missing value. For example, when a special situation occurs such as not many listeners for a specific music track on a specific date, the first streaming server 30 may not provide streaming data corresponding to the listeners of the specific music track, and accordingly, the number of listeners for the specific music track on a specific date may not be calculated.

In this case, the service server 20 may calculate (i.e., infer) the number of listeners in the first city for the first date based on the pre-calculated number of listeners in one or more second cities for the first date and the pre-calculated number of listeners in each of the first city and one or more second cities for a second date prior to the first date. Meanwhile, in Step S610, the service server 20 may also calculate a first current group music streaming indicator related to the number of listeners of the music tracks of the first group artist for the specific date and each of one or more second cities.

According to an embodiment, the service server 20 may calculate the rate of change in the number of listeners for the first date relative to the second date for each of one or more second cities; calculate the average value of the rates of change for each of the one or more second cities; and multiply the number of listeners in the first city for the second date by the average value to calculate the number of listeners in the first city for the first date.

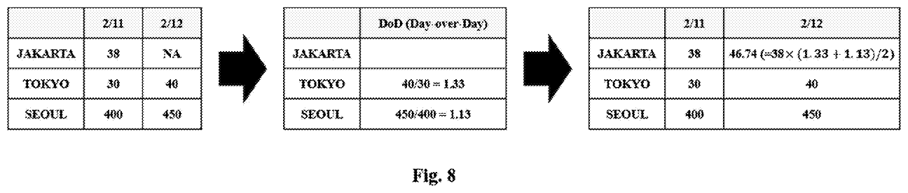

FIG. 8 is a diagram for explaining the concept of the operation of the service server 20 for calculating the first current group music streaming indicator according to an embodiment of the present invention.

Referring to FIG. 8, in Tokyo and Seoul (i.e., second cities), the number of listeners of the first group artist on February 12 is calculated, but in Jakarta (i.e., the first city), the number of listeners of the first group artist on February 12 is not calculated. In this case, the service server 20 may: i) calculate the ratio A of the number of listeners in Tokyo on February 12 to the number of listeners in Tokyo on February 11 (i.e., 1.33); ii) calculate the ratio B of the number of listeners in Seoul on February 12 to the number of listeners in Seoul on February 11 (i.e., 1.13); iii) calculate the average value of ratio A and ratio B; and iv) multiply the average value by the number of listeners in Jakarta on February 11 to calculate the number of listeners in Jakarta on February 12.

Meanwhile, the first current group music streaming indicator may be calculated from the streaming data of the aforementioned Spotify. In this case, the number of listeners who listened to the music tracks of the first group artist may correspond to the number of listeners who listened to the music tracks of the first group artist at least once during the first period.

Referring again to FIG. 7, the second and third current group music streaming indicators will be described.

According to an embodiment, the second current group music streaming indicator may be related to the number of music tracks of the first group artist listed on the music chart of the first city on the specific date, and the third current group music streaming indicator may be related to the number of music albums of the first group artist listed on the music chart of the first city on the specific date.

As an example, when the number of music tracks of the first group artist listed on the music charts of each of three streaming servers 30 on the specific date are M1, M2, and M3 respectively, the service server 20 may calculate the second current group music streaming indicator based on the average or weighted average of M1, M2, and M3. When the number of music albums of the first group artist listed on the music charts of each of three streaming servers 30 on the specific date are N1, N2, and N3 respectively, the service server 20 may calculate the third current group music streaming indicator based on the average or weighted average of N1, N2, and N3.

Meanwhile, the second current group music streaming indicator may be calculated from streaming data for the music charts of the first city on each of the aforementioned Spotify, Apple Music, Deezer, iTunes, Shazam, and Amazon Music. In this case, for Shazam, streaming data for the music chart of the first country to which the first city belongs may additionally be used. The third current group music streaming indicator may be calculated from streaming data for the music charts of the first city on each of the aforementioned Apple Music, Deezer, iTunes, and Amazon Music.

Next, in Step S612, the service server 20 may calculate a current group video streaming indicator of the first group artist for the specific date and the first city based on streaming data from one or more second streaming servers 30.

As described above, the second streaming server 30 may be a streaming server providing video streaming platform services. In addition, the current group video streaming indicator may be related to videos of the first group artist.

Specifically, the service server 20 may calculate the current group video streaming indicator based on the view count of the first group artist's videos on the specific date. View counts may be aggregated for viewers worldwide.

Here, the first group artist's videos may be videos produced by a video creator based in the first city, based on the music tracks of the first group artist. That is, the video creator may be a creator residing in the first city.

Meanwhile, the current group video streaming indicator may be calculated from the streaming data of the aforementioned YouTube.

Continuing to Step S613, the service server 20 may calculate the current group streaming index based on the current group music streaming indicator and the current group video streaming indicator.

As an example, the service server 20 may calculate the current group streaming index as the total sum or weighted sum of the current group music streaming indicator and the current group video streaming indicator.

Meanwhile, Step S612 may not be performed, and in Step S613, the service server 20 may calculate the current group streaming index based solely on the current group music streaming indicator.

Referring again to FIG. 3, in Step S620, the service server 20 may set a group streaming weight.

Here, the group streaming weight is a weight related to the current group streaming index and may have any value between 0 and 1. The group streaming weight may be set based on whether the first group artist has performed group activities within a preset second period and the number of member artists included in the first group artist.

According to a fourth embodiment, when the first group artist is composed of two or more member artists including the first member artist and the first group artist performs group activities within the second period, the service server 20 may set the group streaming weight to have a first value corresponding to the contribution of the first member artist to the first group artist.

Specifically, although not shown in FIG. 6, the service server 20 may further include a step of calculating a fandom index for each of two or more member artists for the specific date and the first city.

As described above, log data corresponding to online fandom activities may be stored in the storage unit 24, and the service server 20 may calculate a fandom index for each of two or more member artists for the specific date and the first city based on the log data. Here, the fandom index may be calculated based on at least one of the first and second fandom indicators.

More specifically, the first fandom indicator may be related to a popularity vote for member artists in the first city conducted on the service server 20. Here, the popularity vote may be a free popularity vote, including a preliminary popularity vote and a main popularity vote. The value of the popularity vote may be the cumulative value of member artist popularity votes up to the specific date.

In addition, the second fandom indicator may be related to payment information of fans based in the first city for goods related to the member artist. Here, goods may include fan goods of the member artist, concert tickets, participation in paid popularity votes, and the like.

As an example, the payment information may be information about payment for goods using digital assets sold for a fee on the service server 20. As another example, the payment information may be information about direct payment for goods using a credit card or the like through the service server 20.

Meanwhile, the fandom index may be further calculated based on various additional fandom indicators. Here, additional fandom indicators may include at least one of: the number of follows of the member artist's community opened on the service server 20; the number of searches in the community; the number of views of the community; the number of posts written in the community; the number of times posts are saved; the number of views of posts; the number of comments on posts; the number of likes on comments; the number of views of content associated with the member artist; the number of times content is saved; the number of likes on content; the number of comments on content; the number of likes on comments on content; and the number of participations in events associated with the member artist.

Once the fandom indices for each of two or more member artists included in the aforementioned first group artist are calculated, in Step S620, the service server 20 may calculate the first value based on the fandom indices for each of the two or more member artists. According to an embodiment, the service server 20 may set the ratio of the fandom index of the first member artist to the sum or weighted sum of the fandom indices of the two or more member artists as the first value.

According to a fifth embodiment, when the first group artist is a solo artist including only the first member artist, the service server 20 may set the group streaming weight to have a preset second value. In this case, the second value may have a fixed value.

According to a sixth embodiment, when the first group artist is composed of two or more member artists including the first member artist but the first group artist does not perform group activities during the second period, the service server 20 may set the group streaming weight to have the second value. That is, since the aforementioned first member artist is essentially a solo artist, the first member artist may be assigned the same group streaming weight as a solo artist.

In Step S630, the service server 20 may calculate the current popularity index of the first member artist for the specific date and the first city based on the current group streaming index of the first group artist and the group streaming weight of the first member artist.

According to an embodiment, the service server 20 may calculate the current popularity index of the first member artist by multiplying the group streaming weight of the first member artist and the current group streaming index of the first group artist.

Meanwhile, there may be cases where the first group artist is composed of two or more member artists including the first member artist, and within the second period, the first group artist performs group activities while the first member artist also performs solo activities. In this case, the current streaming index related to the solo activities of the first member artist must be included in the current popularity index of the first member artist. Therefore, the service server 20 may further calculate a current member streaming index of the first member artist performing solo activities, further set a member streaming weight related to the current member streaming index, and calculate the current popularity index of the first member artist further based on the current member streaming index and the member streaming weight.

Specifically, in Step S610, the service server 20 may further calculate a current member streaming index of the first member artist for the specific date and the first city based on streaming data from the plurality of streaming servers 30. Here, the current member streaming index may be calculated similarly to the current group streaming index described above.

More specifically, the current member streaming index may be calculated based on a current member music streaming indicator, and may further be calculated based on a current member video streaming indicator. In this case, the current member music streaming indicator may be calculated based on at least one of: a first current member music streaming indicator related to the number of listeners who listened to the music tracks of the first member artist in the first city during the first period; a second current member music streaming indicator related to the number of music tracks of the first member artist listed on the music chart of the first city on the specific date; and a third current member music streaming indicator related to the number of music albums of the first member artist listed on the music chart of the first city on the specific date. In addition, the current member video streaming indicator may be calculated based on the view count of videos of the first member artist on the specific date, and the videos of the first member artist may be videos related to the music tracks of the first member artist.

Thereafter, in Step S620, the service server 20 may further set a member streaming weight. In this case, the member streaming weight may have any value between 0 and 1, and in particular may be set to the second value. Meanwhile, the group streaming weight may be set to the first value corresponding to the aforementioned contribution.

Next, in Step S630, the service server 20 may calculate the current popularity index of the first member artist further based on the current member streaming index and the member streaming weight.

According to an embodiment, the service server 20 may calculate the current popularity index of the first member artist based on a first operation value derived from a first average value of the group streaming weight and the member streaming weight and a second average value of the current group streaming index and the current member streaming index. As an example, the first operation value may be a multiplication of the first average value and the second average value. This may be expressed as Equation 4 below.

Current Popularity Index=((Group Streaming Weight+Member Streaming Weight /2) ×((Current Group Streaming Index+Current Member Streaming Index)/ 2) [Equation 4]

According to another embodiment, the service server 20 may calculate the current popularity index of the first member artist based on a second operation value derived from a first multiplication value of the group streaming weight and the current group streaming index and a second multiplication value of the member streaming weight and the current member streaming index. As an example, the second operation value may be the average of the first and second multiplication values. This may be expressed as Equation 5 below.

Current Popularity Index=(Group Streaming Weight×Current Group Streaming Index)+(Member Streaming Weight×Current Member Streaming Index) [Equation 5]

Referring again to FIG. 6, in Step S640, the service server 20 may calculate first and second current final popularity indices based on the current popularity index of the first member artist.

According to an embodiment, the first current final popularity index may be defined as an intra-city popularity index in which popularity indices of a plurality of member artists in a specific city are ranked.

To this end, in Step S610, the service server 20 may further calculate a current group streaming index for each of one or more second group artists for the specific date and the first city. In this case, the current group streaming index may be calculated using only the current group music streaming indicator. In addition, in Step S620, the service server 20 may further set a group streaming weight for each of one or more second group artists for the first city. In addition, in Step S630, the service server 20 may further calculate a current popularity index for each of a plurality of second member artists for the specific date and the first city based on the current group streaming index and group streaming weight for each of one or more second group artists. Here, each of the plurality of second member artists may be included in any one of a plurality of group artists including the first group artist and one or more second group artists.

When the aforementioned Steps S610, S620, and S630 are performed, in Step S640, the service server 20 may calculate the intra-city popularity index by normalizing or standardizing and then ranking the current popularity index of the first member artist and the current popularity indices of each of the plurality of second member artists.

According to an embodiment, the second current final popularity index may be defined as an inter-city popularity index in which popularity indices of a specific member artist across a plurality of cities are ranked.

To this end, in Step S610, the service server 20 may further calculate a current group streaming index for each of one or more second cities for the specific date and the first group artist, and in Step S620, the service server 20 may further set a group streaming weight for each of one or more second cities for the first group artist. In addition, in Step S630, the service server 20 may further calculate the current popularity index of the first member artist for the specific date and each of the one or more second cities based on the current group streaming index and group streaming weight for each of the one or more second cities.

When the aforementioned Steps S610, S620, and S630 are performed, in Step S640, the service server 40 may normalize or standardize and then rank the current popularity index of the first member artist for the first city and the current popularity index of the first member artist for each of the one or more second cities.

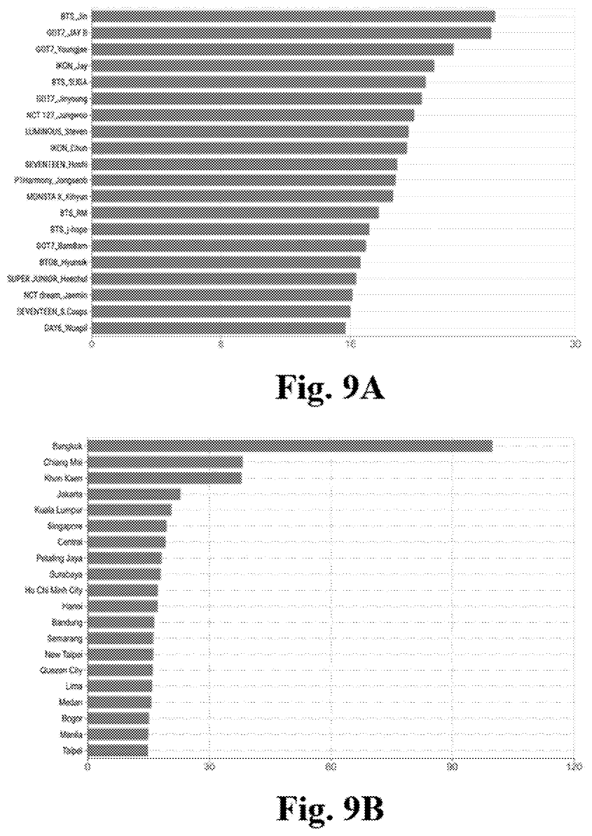

FIG. 9A and FIG. 9B are a diagram illustrating an example of an intra-city popularity index and an inter-city popularity index as defined in the present invention. FIG. 9A illustrates examples of the intra-city popularity index and FIG. 9B illustrates examples of the inter-city popularity index.

In summary, the service server 20 according to the present invention can effectively calculate a total popularity index or current popularity index for each member artist.

In addition, the service server 20 according to the present invention can compare and provide an intra-city popularity index in which total popularity indices of a plurality of member artists in a specific city are ranked, and an inter-city popularity index in which total popularity indices of a specific member artist across a plurality of cities are ranked.

Alternatively, the service server 20 according to the present invention can compare and provide an intra-city popularity index in which popularity indices of a plurality of member artists in a specific city are ranked, and an inter-city popularity index in which popularity indices of a specific member artist across a plurality of cities are ranked.

Meanwhile, according to another embodiment of the present invention, the service server 20 may also calculate the total popularity index of the first member artist using only the total group streaming index of the first member artist without using the fandom index of the first member artist. Reference is made to the description above.

In addition, embodiments of the present invention may be implemented in the form of program instructions that can be executed through various computer means and recorded on a computer-readable medium. The computer-readable medium may include program instructions, data files, data structures, and the like, alone or in combination. The program instructions recorded on the medium may be specially designed and configured for the present invention, or may be known and usable by those skilled in computer software. Examples of computer-readable recording media include magnetic media such as hard disks, floppy disks, and magnetic tapes; optical media such as CD-ROMs and DVDs; magneto-optical media such as floptical disks; and hardware devices specially configured to store and execute program instructions, such as ROM, RAM, and flash memory. Examples of program instructions include not only machine language code such as that generated by a compiler, but also high-level language code that can be executed by a computer using an interpreter or the like. The hardware devices described above may be configured to operate as one or more software modules to perform the operations of the embodiments of the present invention, and vice versa.

As described above, the present invention has been described by specific matters such as specific components and limited embodiments and drawings, but these are provided only to assist in the overall understanding of the present invention, and the present invention is not limited to the above embodiments, and various modifications and variations can be made by those skilled in the art to which the present invention belongs from these descriptions. Therefore, the spirit of the present invention should not be limited to the described embodiments, and all things that are equivalent or equivalent modifications to the claims as well as the claims described below belong to the scope of the spirit of the present invention.

What is claimed is:

1. A method for calculating a popularity index performed in a service server, comprising:
a streaming index calculation step of calculating a total group streaming index of a first group artist for a specific date and a first city based on streaming data from a plurality of streaming servers, wherein the first group artist is composed of one or more member artists including a first member artist;
a fandom index calculation step of calculating a fandom index of the first member artist for the specific date and the first city based on log data of the service server corresponding to online fandom activities; and
a popularity index calculation step of calculating a total popularity index of the first member artist for the specific date and the first city based on the total group streaming index and the fandom index.

2. The method of claim 1, wherein the streaming index calculation step:
calculates a total group music streaming indicator of the first group artist related to music tracks and/or music albums of the first group artist for the specific date and the first city based on streaming data from two or more first streaming servers providing music streaming services among the plurality of streaming servers; and
calculates the total group streaming index based on the total group music streaming indicator.

3. The method of claim 2, wherein the streaming index calculation step calculates the total group music streaming indicator based on at least one of first, second, and third total group music streaming indicators, wherein:
the first total group music streaming indicator is related to the number of listeners who listened to the music tracks of the first group artist in the first city up to the specific date;
the second total group music streaming indicator is related to the number of music tracks of the first group artist listed on the music chart of the first city up to the specific date; and
the third total group music streaming indicator is related to the number of music albums of the first group artist listed on the music chart of the first city up to the specific date.

4. The method of claim 2, wherein the streaming index calculation step:
calculates a total group video streaming indicator of the first group artist related to videos of the first group artist for the specific date and the first city based on streaming data from one or more second streaming servers providing video streaming services among the plurality of streaming servers; and
calculates the total group streaming index further based on the total group video streaming indicator.

5. The method of claim 4, wherein the videos of the first group artist are produced by a video creator based in the first city based on music tracks of the first group artist, and the streaming index calculation step calculates the total group video streaming indicator based on the view count of the first group artist's videos up to the specific date.

6. The method of claim 1, wherein the fandom index calculation step calculates the fandom index by calculating at least one of first and second fandom indicators, wherein:
the first fandom indicator is related to a popularity vote for the first member artist in the first city conducted on the service server; and
the second fandom indicator is related to payment information of fans based in the first city for goods related to the member artist.

7. The method of claim 1, wherein the first group artist is composed of two or more member artists including the first member artist, and wherein the fandom index calculation step, when the log data of the first member artist is missing data:
further calculates a fandom index of other member artists of the first group artist for the specific date and the first city based on the log data; and
calculates the fandom index of the first member artist based on a statistical value of the fandom indices of the other member artists.

8. The method of claim 1, wherein when the first group artist is composed of two or more member artists including the first member artist and, within a preset specific period, the first group artist performs group activities while the first member artist performs solo activities:
the streaming index calculation step further calculates a total member streaming index of the first member artist for the specific date and the first city based on streaming data from the plurality of streaming servers; and
the popularity index calculation step calculates the total popularity index further based on the total member streaming index.

9. The method of claim 1, further comprising:
a weight-setting step of setting a group streaming weight related to the total group streaming index and a fandom weight related to the fandom index,
wherein the popularity index calculation step calculates the total popularity index further based on the group streaming weight and the fandom weight.

10. The method of claim 9, wherein when the first group artist is composed of two or more member artists including the first member artist and the first group artist performs group activities within a preset specific period, the weight-setting step sets the group streaming weight to have a first value corresponding to the contribution of the first member artist to the first group artist.

11. The method of claim 10, wherein the fandom index calculation step further calculates a fandom index of other member artists of the first group artist for the specific date and the first city based on the log data, and the weight-setting step calculates as the first value the ratio of the fandom index of the first member artist to the sum or weighted sum of the fandom indices of the first member artist and the other member artists.

12. The method of claim 9, wherein when the first group artist is a solo artist including only the first member artist, or when the first group artist is composed of two or more member artists including the first member artist but the first group artist does not perform group activities during a preset specific period, the weight-setting step sets the group streaming weight to have a preset second value.

13. The method of claim 9, wherein when the first group artist is composed of two or more member artists including the first member artist and, within a preset specific period, the first group artist performs group activities while the first member artist performs solo activities:
the streaming index calculation step further calculates a total member streaming index of the first member artist for the specific date and the first city based on streaming data from the plurality of streaming servers;
the weight-setting step further sets a member streaming weight related to the total member streaming index; and
the popularity index calculation step calculates the total popularity index further based on the total member streaming index and the member streaming weight.

14. The method of claim 13, wherein the weight-setting step sets the group streaming weight to have a first value corresponding to the contribution of the first member artist to the first group artist, and sets the member streaming weight to have a preset second value.

15. The method of claim 13, wherein the popularity index calculation step:
calculates a first operation value or a second operation value;
calculates a third operation value based on the fandom weight and the fandom index; and
calculates the total popularity index based on the first operation value and the third operation value, or based on the second operation value and the third operation value,
wherein the first operation value is calculated based on a first average value of the group streaming weight and the member streaming weight and a second average value of the total group streaming index and the total member streaming index, and
the second operation value is calculated based on a first multiplication value of the group streaming weight and the total group streaming index and a second multiplication value of the member streaming weight and the total member streaming index.

16. The method of claim 1, wherein:
the streaming index calculation step further calculates a total group streaming index for each of one or more second group artists for the specific date and the first city;
the fandom index calculation step further calculates a fandom index for each of a plurality of second member artists for the specific date and the first city based on log data of the service server, wherein each of the plurality of second member artists is included in any one of a plurality of group artists including the first group artist and the one or more second group artists;
the popularity index calculation step further calculates a total popularity index for each of the plurality of second member artists for the specific date and the first city based on the total group streaming index for each of the one or more second group artists and the fandom index for each of the plurality of second member artists; and
the method further comprises a popularity index ranking step of ranking the total popularity index of the first member artist and the total popularity indices of each of the plurality of second member artists.

17. The method of claim 1, wherein:
the streaming index calculation step further calculates a total group streaming index for each of one or more second cities for the specific date and the first group artist;
the fandom index calculation step further calculates a fandom index for each of the one or more second cities for the specific date and the first member artist based on log data of the service server;
the popularity index calculation step further calculates the total popularity index of the first member artist for the specific date and each of the one or more second cities based on the total group streaming index for each of the one or more second cities and the fandom index for each of the one or more second cities; and
the method further comprises a popularity index ranking step of ranking the total popularity index of the first member artist for the first city and the total popularity index of the first member artist for each of the one or more second cities.

18. A method for calculating a popularity index performed in a service server, comprising:
a streaming index calculation step of calculating a total group streaming index of a first group artist for a specific date and a first city based on streaming data from a plurality of streaming servers, wherein the first group artist includes a first member artist; and
a popularity index calculation step of calculating a total popularity index of the first member artist for the specific date and the first city based on the total group streaming index and a predefined group streaming weight.

19. A non-transitory computer-readable recording medium having a program recorded thereon for executing the method according to claim 1.

20. A service server comprising:
a memory storing computer-readable instructions; and
a processor implemented to execute the instructions,
wherein the processor:
calculates a total group streaming index of a first group artist for a specific date and a first city based on streaming data from a plurality of streaming servers, wherein the first group artist is composed of one or more member artists including a first member artist;
calculates a fandom index of the first member artist for the specific date and the first city based on log data of the service server corresponding to online fandom activities; and
calculates a total popularity index of the first member artist for the specific date and the first city based on the total group streaming index and the fandom index.
